(19) United States
(12) Patent Application Publication
(10) Pub. No.: US 2003/0041302 A1
(43) Pub. Date: Feb. 27, 2003

(54) Markup language accelerator

(76) Inventor: Robert G. McDonald, Austin, TX (US)

Correspondence Address: Lawrence J. Merkel, Conley, Rose, & Tayon, P.C., P.O. Box 398, Austin, TX, 78767, US

(21) Appl. No.: 09/922,515

(22) Filed: Aug. 3, 2001

(51) Int. Cl. G06F 7/00

(52) U.S. Cl. 715/513

(57) ABSTRACT

A markup language accelerator is coupled to receive a pointer to markup language data (e.g. from software executing on a CPU) and is configured to perform at least some of the parsing of the markup language data. For example, the markup language accelerator may parse the markup language data into tokens delimited by delimiters defined in the markup language. The software may communicate with the markup language accelerator using one or more commands to determine the various token types in the markup language data and, in some cases, may receive pointers to the tokens within the markup language data.

### BACKGROUND OF THE INVENTION

1. Field of the Invention

This invention is related to the field of markup language processing.

2. Description of the Related Art

Markup languages are used for a variety of purposes. Generally, a markup language is a mechanism for identifying structure for the content of a file. Many types of content may have structure associated with it. For example, Hypertext Markup Language (HTML) is used to indicate the structure of the content on a web page (e.g. where on the screen the information is placed, how it is displayed, etc.). The Standard Generalized Markup Language (SGML) (International Standards Organization (ISO) 8879) is a language for specifying element tags, which may carry the information identifying the structure of the tagged content. Another markup language is the Extensible Markup Language (XML), which is similar to SGML but optimized for web content. XML may be used to specify web pages, but also a variety of other types of content, such as messages between applications communicating via the web or another network, messaging protocols for web services, etc. A cross between HTML and XML is referred to as Extensible HTML (XHTML). Yet another example of a markup language is the wireless markup language (WML). Numerous other markup languages exist, including a variety of markup languages based on XML.

Generally, software programs are used to read markup language data, parse the markup language data, interpret the parsed data, and finally act on the interpreted parsed data (e.g. display the content according to the markup requirements, respond to the message included in the markup, etc.).

### SUMMARY OF THE INVENTION

A markup language accelerator is described which is coupled to receive a pointer to markup language data (e.g. from software executing on a CPU) and is configured to perform at least some of the parsing of the markup language data. For example, the markup language accelerator may parse the markup language data into tokens delimited by delimiters defined in the markup language. The software may communicate with the markup language accelerator using one or more commands to determine the various token types in the markup language data and, in some cases, may receive pointers to the tokens within the markup language data.

Broadly speaking, an apparatus is contemplated comprising a pointer storage configured to store a pointer to markup language data and a circuit coupled to the pointer storage. The circuit is configured to parse the markup language data into one or more tokens, each token comprising one or more characters from the markup language data. The circuit is configured to parse the markup language data responsive to one or more delimiters in the markup language data. An carrier medium is also contemplated which carries one or more data structures representative of the apparatus.

### BRIEF DESCRIPTION OF THE DRAWINGS

The following detailed description makes reference to the accompanying drawings, which are now briefly described.

FIG. 1 is a block diagram of one embodiment of a system including one embodiment of a markup language accelerator.

FIG. 2 is a block diagram illustrating interfaces between various components for processing markup language data according to one embodiment of the system shown in FIG. 1.

FIG. 3 is a flowchart illustrating operation of one embodiment of the markup language accelerator shown in FIG. 1.

FIG. 4 is a flowchart illustrating one embodiment of a block illustrated in FIG. 3.

FIG. 5 is a state machine diagram illustrating one embodiment of a state machine for detecting markup delimiters according to a second embodiment of the markup language accelerator.

FIG. 6 is a flowchart illustrating operation of the second embodiment of the markup language accelerator.

FIG. 7 is a flowchart illustrating one embodiment of a block illustrated in FIG. 6 for the second embodiment of the markup language accelerator.

FIG. 8 is a block diagram of a third embodiment of a markup language accelerator.

FIG. 9 is a block diagram of a fourth embodiment of a markup language accelerator.

FIG. 10 is a block diagram of a carrier medium.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

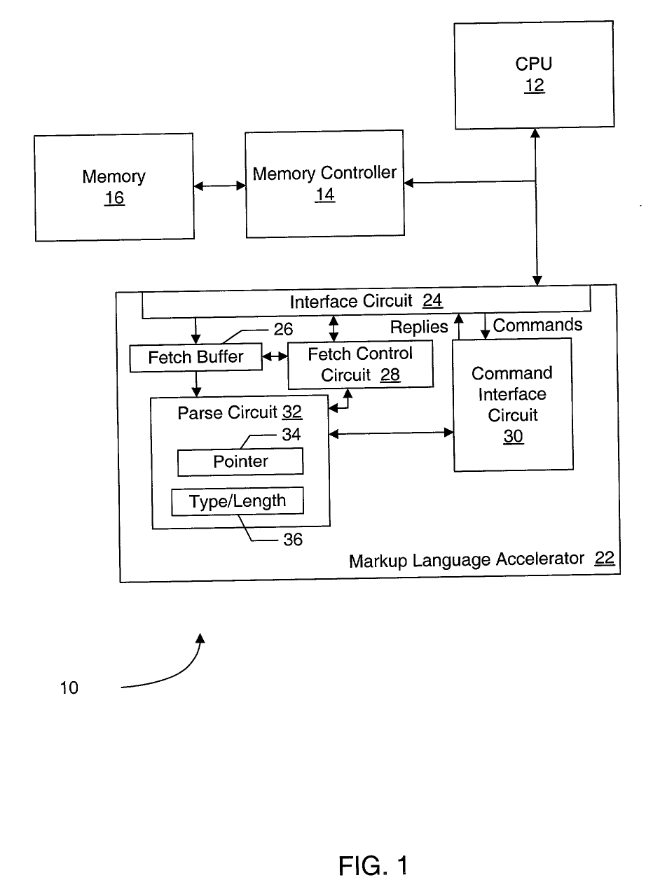

Turning now to FIG. 1, a block diagram of one embodiment of a system 10 is shown. Other embodiments are possible and contemplated. The illustrated system 10 includes a central processing unit (CPU) 12, a memory controller 14, a memory 16, and a markup language accelerator 22. The CPU 12 is coupled to the memory controller 14 and the markup language accelerator 22. The memory controller 14 is further coupled to the memory 16. In one embodiment, the CPU 12, the memory controller 14, and the markup language accelerator 22 may be integrated onto a single chip or into a package (although other embodiments may provide these components separately or may integrate any two of the components and/or other components, as desired).

The markup language accelerator 22 is configured to accelerate the processing of markup language data. Generally, the software executing on the CPU 12 may supply markup language accelerator 22 with a pointer to the markup language data. The markup language accelerator 22 may perform at least some of the parsing of the markup language data. The markup language accelerator 22 may be configured to detect one or more delimiters which may be specified by the markup language, and may identify tokens delimited by those delimiters. As used herein, a token is a string of one or more characters from the markup language data, delimited by the delimiters recognized by the markup language accelerator 22. The markup language accelerator may provide indications of the tokens to the CPU 12.

In one embodiment, the software may execute commands directed to the markup language accelerator 22 to provide a pointer to the markup language data and to request information on the tokens identified by the markup language accelerator. For example, the commands may include a command to request an indication of what the next token is (e.g. the type of token), and a command to retrieve a pointer to the token. The markup language accelerator 22 may parse tokens ahead of the current token received by the software or may use the commands to trigger the parsing of the next token, as desired. The software previously used to perform the parsing performed by the markup language accelerator 22 may be removed from the software executing on the CPU 12, or may not be executed unless an abnormality is detected by the markup language accelerator 22 during parsing. Overall efficiency and/or speed of processing the markup language data may be improved.

As used herein, a “delimiter” is a string of one or more characters which is defined to delimit a token. A beginning delimiter delimits the beginning of the token. In other words, when scanning from the beginning of the markup language data, the beginning delimiter is encountered prior to the corresponding token. An end delimiter delimits the end of the token. In other words, when scanning from the beginning of the markup language data, the end delimiter is encountered subsequent to the corresponding token. Markup language data refers to a string of characters which comprises structured content according to the markup language in use.

The markup language accelerator 22 may be configured to perform simple parsing (e.g. words delimited by whitespace) or more advanced parsing (e.g. detecting some or all of the delimiters defined in a given markup language). Furthermore, embodiments of the markup language accelerator 22 may have modes in which simple parsing is used, or the more advanced parsing corresponding to one or more markup languages supported by the markup language accelerator 22. Thus, if one of the supported markup languages is being processed, the markup language accelerator 22 may be placed in the corresponding mode. If a markup language not supported by the markup language accelerator 22 is being processed, the markup language accelerator 22 may be placed in the simple parsing mode to provide parsing support.

Generally, the CPU 12 is capable of executing instructions defined in an instruction set. The instruction set may be any instruction set, e.g. the ARM instruction set, the PowerPC instruction set, the x86 instruction set, the Alpha instruction set, the MIPS instruction set, the SPARC instruction set, etc. Generally, the CPU 12 executes software coded in the instruction set and controls other portions of the system in response to the software.

The memory controller 14 receives memory read and write operations from the CPU 12 and the markup language accelerator 22 and performs these read and write operations to the memory 16. The memory 16 may comprise any suitable type of memory, including SRAM, DRAM, SDRAM, RDRAM, or any other type of memory.

It is noted that, in one embodiment, the interconnect between the markup language accelerator 22, the CPU 12, and the memory controller 14 may be a bus (e.g. the Advanced RISC Machines (ARM) Advanced Microcontroller Bus Architecture (AMBA) bus, including the Advanced High-Performance (AHB) and/or Advanced System Bus (ASB)). Alternatively, any other suitable bus may be used, e.g. the Peripheral Component Interconnect (PCI), the Universal Serial Bus (USB), IEEE 1394 bus, the Industry Standard Architecture (ISA) or Enhanced ISA (EISA) bus, the Personal Computer Memory Card International Association (PCMCIA) bus, the Handspring Interconnect specified by Handspring, Inc. (Mountain View, CA), etc. may be used. Still further, the markup language accelerator 22 may be connected to the memory controller 14 and the CPU 12 through a bus bridge (e.g. if the markup language accelerator 22 is coupled to the PCI bus, a PCI bridge may be used to couple the PCI bus to the CPU 12 and the memory controller 14). In other alternatives, the markup language accelerator 22 may be directly connected to the CPU 12 or the memory controller 14, or may be integrated into the CPU 12, the memory controller 14, or a bus bridge. Furthermore, while a bus is used in the present embodiment, any interconnect may be used. Generally, an interconnect is a communication medium for various devices coupled to the interconnect.

In the illustrated embodiment, the markup language accelerator 22 may include an interface circuit 24, a fetch buffer 26, a fetch control circuit 28, a command interface circuit 30, and a parse circuit 32. The parse circuit 32 may be coupled to one or more pointer registers 34 and one or more type/length registers 36. The interface circuit 24 is coupled to the interface to the markup language accelerator 22 (e.g. the interface to the CPU 12 and the memory controller 14) and is further coupled to the fetch buffer 26, the fetch control circuit 28, and the command interface circuit 30. The fetch control circuit 28 is coupled to the fetch buffer 26. The fetch control circuit 28 and the command interface circuit 30 are coupled to the parse circuit 32, which is further coupled to the fetch buffer 26.

Generally, the parse circuit 32 may include circuitry to recognize characters in the markup language data (and to detect invalid characters as an abnormality in the markup language data), as well as circuitry to detect the delimiters within the markup data. The parse circuit 32 may detect the type of token and (in some cases) its length, and record this information in the registers 36. Additionally, the parse circuit 32 may update the pointer in the pointer register 34 to indicate the beginning of the token.

The parse circuit 32 generally consumes markup language data from the fetch buffer 26 as it parses the markup language data. The fetch control circuit 28 may generally fetch the next bytes of the markup language data as the data is consumed from the fetch buffer 26 by the parse circuit 32. The fetch control circuit 28 may attempt to keep the fetch buffer 26 full of markup language data to be processed. The fetch control circuit 28 may read the pointer from the pointer register 34 to generate fetch addresses, which the fetch control circuit 28 may transmit to the interface circuit 24 for reading the memory 16. In other words, the markup language data may be stored in the memory 16 and read therefrom by the markup language accelerator 22 for parsing. The CPU 12 may also access the markup language data from the memory 16, as desired.

The interface circuit 24 is also coupled to receive commands from the interface to the markup language accelerator 22, and may pass these commands to the command interface circuit 30 for processing. The commands may be memory mapped addresses used in load/store instructions, for example. The interface circuit 24 may decode the address range assigned to the memory mapped commands and pass commands, when received, to the command interface circuit 30. In one embodiment, the address range may be divided into a set of service ports, each of which may be assigned to different processes that may be executing in the system 10. The addresses within each service port may decode to various commands. The command interface circuit 30 may communicate with the parse circuit 32 to complete the command (e.g. to obtain the reply information, if a reply is expected, or to provide the command operand to the parse circuit 32).

As used herein, the term “character” may be defined by any encoding system which maps one or more bytes as encodings of various letters, numbers, punctuation, etc. For example, the American Standard Code for Information Interchange (ASCII) and/or Unicode definitions may be used. Thus, each character may comprise one byte, or more than one byte, according to the corresponding definition. The markup language accelerator 22 interprets the markup language data as characters according to the mappings defined in such encoding systems. The term “whitespace” or “whitespace characters” refers to those characters that, when displayed, result in one or more blanks. Whitespace may include the space, tab, carriage return, and new line characters.

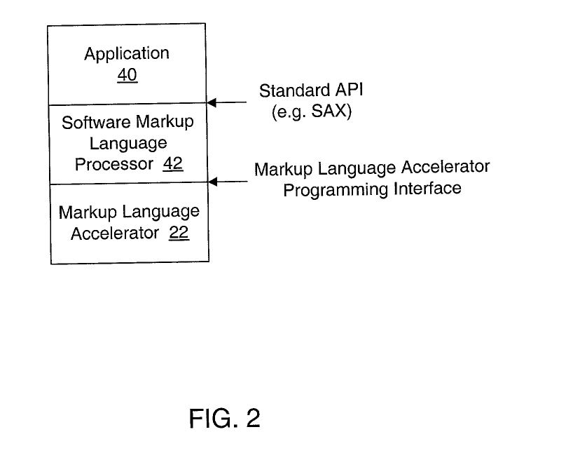

Turning next to FIG. 2, a block diagram illustrating one embodiment of a hierarchy of components for processing markup language data is shown. Other embodiments are possible and contemplated. In the embodiment of FIG. 2, the hierarchy includes an application 40, a software markup language processor 42, and the markup language accelerator 22. The application 40 and the software markup language processor 42 may both be software executing on the CPU 12.

Generally, there may be an application programming interface (API) between the application 40 and the software markup language processor 42. The API may be a standard API (e.g. the simple API for XML, or SAX, for XML embodiments). For an XML embodiment, the application 40 may be an application in the XML definition, and the software markup language processor 42 (in combination with the markup language accelerator 22) may be an XML processor. The software markup language processor 42 may, in turn, have a programming interface to the markup language accelerator 22 as illustrated in FIG. 2. The programming interface may comprise the commands described above.

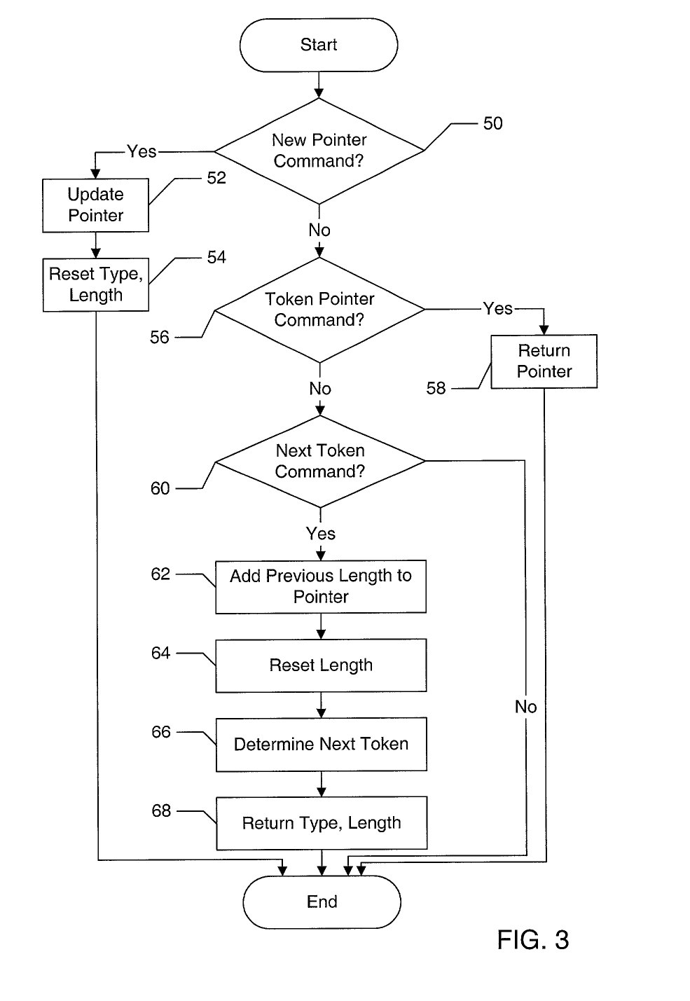

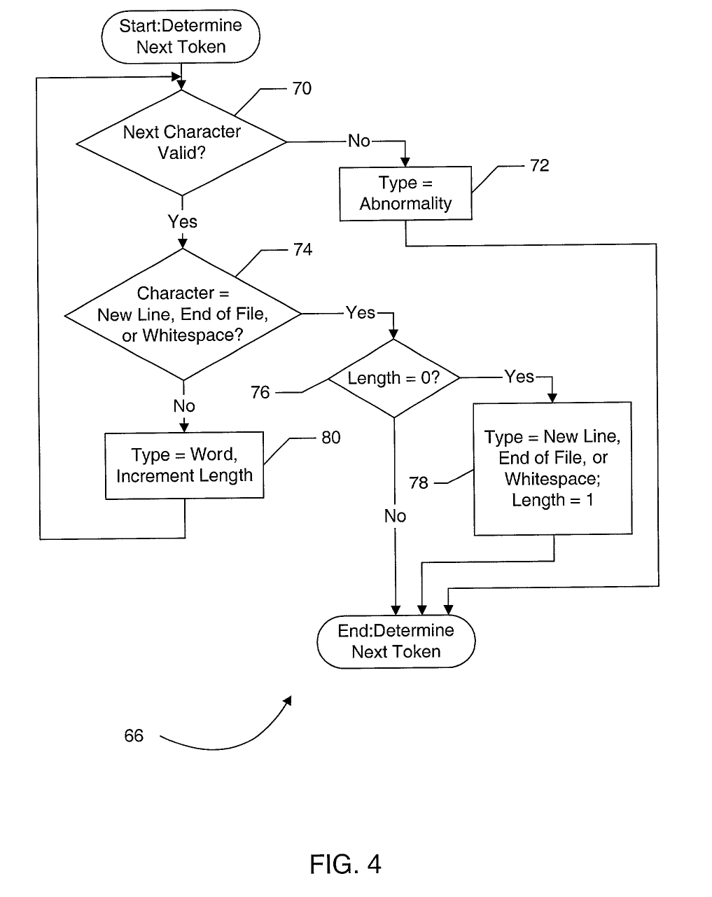

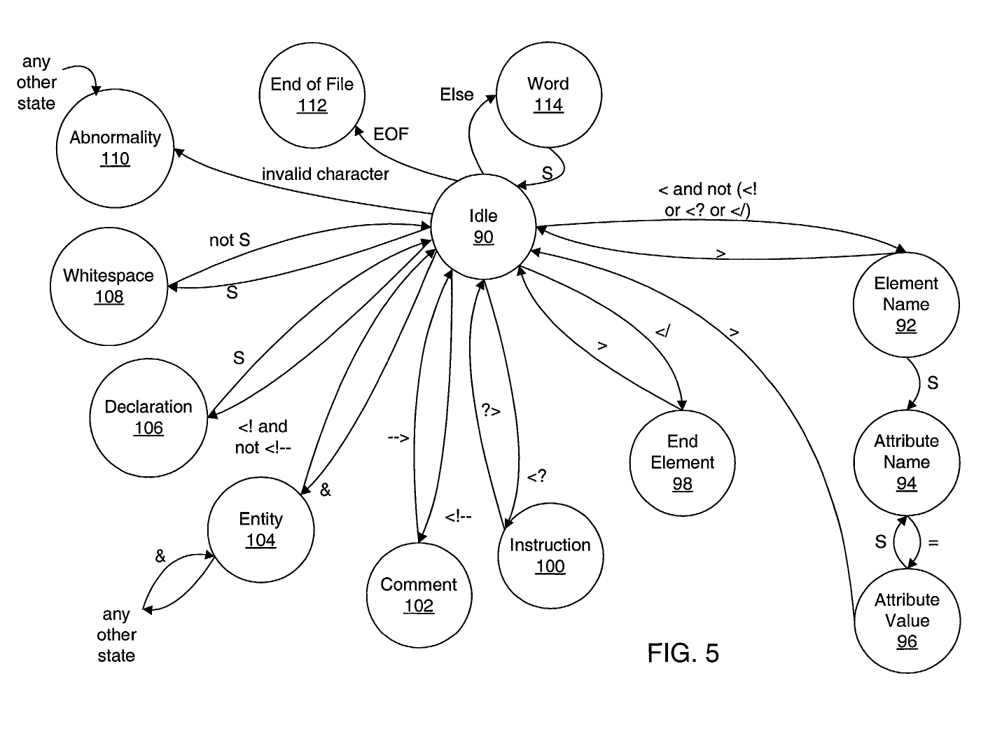

FIGS. 3-4 illustrate operation of an embodiment of the markup language accelerator 22 which performs relatively simple parsing, identifying words delimited by whitespace, whitespace, end of file, and new line events in the markup language data. Such a markup language accelerator may be used within any markup language. FIGS. 5-7 illustrate a more complex embodiment for XML. Other markup languages may be supported in a similar manner to FIGS. 5-7. As mentioned above, some embodiments of the markup language accelerator may include two or more modes, one mode for each markup language supported in the manner of FIGS. 5-7 and a mode for simple parsing such as the manner of FIGS. 3-4.

Turning next to FIG. 3, a flowchart is shown illustrating operation of one embodiment of the markup language accelerator 22. Other embodiments are possible and contemplated. While the blocks shown in FIG. 3 are illustrated in a particular order for ease of understanding, blocks may be performed in other orders, as desired. Furthermore, blocks may be performed in parallel by the circuitry within the markup language accelerator 22. Specifically, circuitry to detect the various commands may operate in parallel. Furthermore, various blocks may occur in different clock cycles in various embodiments.

The illustrated embodiment may support at least three commands: a new pointer command, in which the software executing on the CPU 12 is providing a pointer to markup language data to be processed; a token pointer command, in which the software is requesting a pointer to the most recently detected token in the markup language data being processed; and a next token command, in which the software is requesting an identification of the next token in the markup language data being processed. The response to the next token command may also optionally include the length of the token, if the token has a length. Alternatively, the length may be returned in response to the token pointer command or in response to a separate token length command.

The new pointer command may be a write (e.g. a store) to a first memory mapped address detected by the interface circuit 24 and/or the command interface circuit 30, for the embodiment shown in FIG. 1. The data transferred to the markup language accelerator 22 via the write may be the new pointer. The next token command may be a read (e.g. a load) to a second memory mapped address. The data transferred by the markup language accelerator 22 in response to the read may be an indication of the next token (e.g. type, optionally a length). The token pointer command may be a read (e.g. a load) to a third memory mapped address. The data transferred by the markup language accelerator 22 in response to the read may be the token pointer. Both read addresses may detected by the interface circuit 24 and/or the command interface circuit 30, for the embodiment shown in FIG. 1.

In response to the new pointer command (decision block 50), the markup language accelerator 22 updates the pointer in the pointer register 34 with the new pointer supplied in the new pointer command (block 52). Subsequent parsing may occur beginning at the new pointer. Additionally, in the illustrated embodiment, the type and/or length in the type/length registers 36 may be reset (since the pointer has been redirected, the length of the previously detected token may no longer be valid) (block 54).

In response to the token pointer command (decision block 56), the markup language accelerator 22 returns the pointer from the pointer register 34 (block 58). It is anticipated that the token pointer command may normally follow the next token command in time, and thus the pointer may be pointing to the most recently located token in the markup language data.

In response to the next token command (decision block 60), the markup language accelerator 22 may generally process the markup data subsequent to the most recently detected token to identify and locate the next token in the markup language data. An exemplary set of blocks are illustrated in FIG. 3. The length of the previously detected token may be added to the pointer (which is pointing to the previously detected token) to advance the current pointer past the previously detected token (block 62). In addition to the length of the previous token, the pointer may further be incremented by the size of the end delimiter for the token (thereby skipping the end delimiter in the markup data). The previous length may then be reset, so that the new length may be calculated (if appropriate for the type of token detected) (block 64). The markup language accelerator 22 (specifically, the parse circuit 32 in the embodiment of FIG. 1) determines the type (and optionally the length) of the next token (block 66), and the type and optionally the length is returned (block 68).

In the embodiment of FIG. 3, the next token is parsed in response to the next token command. Alternatively, the first token may be parsed in response to the new pointer command, and thus the type, pointer, and length may be already generated when the next token command is received. In response to the next token command, the previously generated token information may be provided. Additionally, another token may be located in response to the next token command. In such an embodiment, there may be separate registers to store information on the most recently detected token and the previously detected token.

Turning now to FIG. 4, a flowchart illustrating operation of one embodiment of the markup language accelerator 22 for one embodiment of block 66 is shown. Other embodiments are possible and contemplated. While the blocks shown in FIG. 4 are illustrated in a particular order for ease of understanding, blocks may be performed in other orders, as desired. Furthermore, blocks may be performed in parallel by the circuitry within the markup language accelerator 22. Still further, various blocks may occur in different clock cycles in various embodiments.

The markup language accelerator 22 determines if the next set of one or more bytes (from the fetch buffer 26) is a valid character (decision block 70). If not, the markup language accelerator 22 classifies the token as an abnormality (block 72). If the next set of bytes is a valid character, the markup language accelerator 22 determines if the character is a new line, end of file, or other whitespace character (decision block 74). These may be the delimiters in this embodiment. If the character is a new line, end of file, or other whitespace character and the length is zero (in other words, the first character in the next token is one of the above—decision block 76), the type is set to new line, end of file, or whitespace, as appropriate (block 78). If the length is not zero, the new line, end of file, or other whitespace character is the end delimiter of a word and thus the next token's length and type are complete.

If the character is not a new line, end of file, or other whitespace character, then the character may be part of a word (assuming there is no abnormality in the word). Thus, the markup language accelerator 22 may set the type to word and increment the length by the length of the character (block 80). The blocks of FIG. 4 may be repeated for the next character.

While the flowchart of FIG. 4 illustrates processing one character at a time, embodiments of the markup language accelerator may process multiple bytes in parallel, if desired.

Turning now to FIG. 5, a block diagram of an exemplary state machine corresponding to an XML embodiment is shown. Other embodiments are possible and contemplated.

The state machine of FIG. 5 includes an idle state 90, an element name state 92, an attribute name state 94, an attribute value state 96, an end element state 98, an instruction state 100, a comment state 102, an entity state 104, a declaration state 106, a whitespace state 108, an abnormality state 110, an end of file state 112, and a word state 114.

XML defines elements, attributes, processing instructions, comments, entities, and declarations. Elements indicate the nature of the content they surround. Thus, elements have a start tag and an end tag, with the content corresponding to the element positioned between the start tag and the end tag. Elements may have attributes, which are assigned attribute values within the start tag. Entities are names for content, and are expanded into the corresponding content during processing. Comments are not considered part of the XML document, but may be used to record information in the document for reference at a later time if the XML source is being viewed. Processing instructions are messages/commands passed to the XML application 40. Declarations may be used to describe constraints, default values, definition, etc. for elements, attributes, entities, and XML documents.

Each of the element name state 92, the attribute name state 94, the attribute value state 96, the end element state 98, the instruction state 100, the comment state 102, the entity state 104, and the declaration state 106 may correspond to XML markup. The element name state 92 may correspond to an element start tag in the markup data. The element name may be available at the pointer, and the token type may indicate element name. The attribute name state 94 may correspond to an attribute name within an element start tag. The attribute name may be available at the pointer and the token type may indicate attribute name. The attribute value state 96 corresponds to an attribute value within an element start tag. The attribute value may be available at the pointer, and the token type may indicate attribute value. The end element state 98 corresponds to the end tag of an element in the markup data. The element name may be available at the pointer and the token type may indicate end element. The instruction state 100 may correspond to a processing instruction in the markup data. The instruction may be available at the pointer, and the token type may indicate instruction. The comment state 102 may correspond to a comment in the markup data. The beginning of the comment text may be available at the pointer and the token type may indicate comment. The entity state 104 may correspond to an entity reference in the markup data. The entity reference may be available at the pointer, and the token type may indicate entity reference. The declaration state 106 may correspond to a declaration in the markup data, and the declaration text may be available at the pointer.

The other states in FIG. 5 may be used to identify other types of tokens that may occur in the XML data. The whitespace state 108 is used if whitespace is encountered in situations in which the whitespace is not a delimiter. The abnormality state 110 is used if an abnormality is detected in the XML data (e.g. an invalid character, or markup-specific abnormalities). The end of file state 112 is used if the end of file character is detected. The word state 114 is used if the next character(s) do not delimit any of the other detected token types. For example, content may be parsed a word at a time since it is not delimited by markup delimiters.

Generally, the state machine of FIG. 5 illustrates the delimiters which are recognized by the markup language accelerator 22 for various token types supported in the embodiment of FIG. 5. The name of the state is the token type. The arrow entering the state is labeled with the character(s) forming the beginning delimiter for that token type, and the arrow(s) leaving the state is (are) labeled with the character(s) forming the ending delimiter for that token type.

The idle state 90 is the state returned to when the current token has no effect on the interpretation of the delimiters for the next token. In some cases, the meaning of a delimiter (or the token type detected for a given delimiter) of the next token may be dependent on the current token. For the embodiment of FIG. 5, examples include the attribute name state 94 and the attribute value state 96. An attribute name token is detected if the previous token is an element name and the end delimiter for the element name (and beginning delimiter of the attribute name) is whitespace. Attribute name tokens are not detected unless the preceding token was an element name with an end delimiter of whitespace.

The beginning delimiter for an element name token (element name state 92) comprises a less than character (“<”) followed by another character which is not an exclamation point character (“!”), a question mark character (“?”), or a forward slash character (“/”). The end delimiter comprises either a whitespace character (“S”), in which case the next token is an attribute name (the attribute name state 94 is the next state), or a greater than character (“>”), in which case the next token may be anything (the idle state 90 is the next state).

The beginning delimiter for an attribute name token (attribute name state 94) is the same as one of the end delimiters for an element name—whitespace (“S”). The end delimiter comprises an equal sign character (“=”) and the next token is an attribute value (the attribute value state 96 is the next state).

The beginning delimiter for an attribute value token (attribute value state 96) is the same as the end delimiter for an attribute value (“=”). The end delimiter comprises either a whitespace character (“S ”), in which case the next token is an attribute name (the attribute name state 94 is the next state), or a “>”, in which case the next token may be anything (idle state 90 is the next state).

The beginning delimiter for an end element token (end element state 98) comprises a less than character (“<”) followed by a forward slash character (“/”). The end delimiter comprises a greater than character (“>”) and the next token may be anything (the idle state 90 is the next state).

The beginning delimiter for an instruction token (instruction state 100) comprises a less than character (“<”) followed by a question mark character (“?”). The end delimiter comprises a question mark character (“?”) followed by a greater than character (“>”) and the next token may be anything (the idle state 90 is the next state).

The beginning delimiter for a comment token (comment state 102) comprises a less than character (“<”) followed by an exclamation point character (“!”) followed further by two dash characters (“-”). The end delimiter comprises two dash characters (“-”) followed by a greater than character (“>”) and the next token may be anything (the idle state 90 is the next state).

The beginning delimiter for an entity token (entity state 104) comprises an ampersand character (“&”). The end delimiter comprises a semicolon character (“;”) and the next token may be anything (the idle state 90 is the next state). Additionally, entity references may occur at any time. Thus, transitions to and from the entity state 104 are shown from any other state in FIG. 5. If an entity reference is encountered in a state other than the idle state 90, the token corresponding to that state may be ended (as if the end delimiter was reached) and the state may transition to the entity state 104. The entity token may next be supplied, followed by another token of the same type as before the entity token. In other embodiments, such entity tokens may not be detected (or entity tokens may not be detected at all), and the XML processor software may handle the parsing of entities.

The beginning delimiter for a declaration token (declaration state 106) comprises a less than character (“<”) followed by an exclamation point character (“!”) and further followed by at least two characters which are not both dash characters (“-”). The end delimiter comprises whitespace (“S”) and the next token may be anything (the idle state 90 is the next state). In this embodiment, the declaration name may be the token indicated by the pointer. In other embodiments, the entire declaration may be the declaration token, in which case the end delimiter may be a greater than character (“>”) optionally preceded by one or more close bracket characters (“]”) depending on the number of open bracket characters (“[”) in the declaration token.

The beginning delimiter for a whitespace token (whitespace state 108) comprises a whitespace character (“S”). The end delimiter comprises anything but a whitespace character (“not S”).

The beginning delimiter for a word token (word state 114) comprises any character (or string of characters) which does not result in another token type or an abnormality or end of file. The end delimiter comprises a whitespace character (“S”) and the next token may be anything (the idle state 90 is the next state).

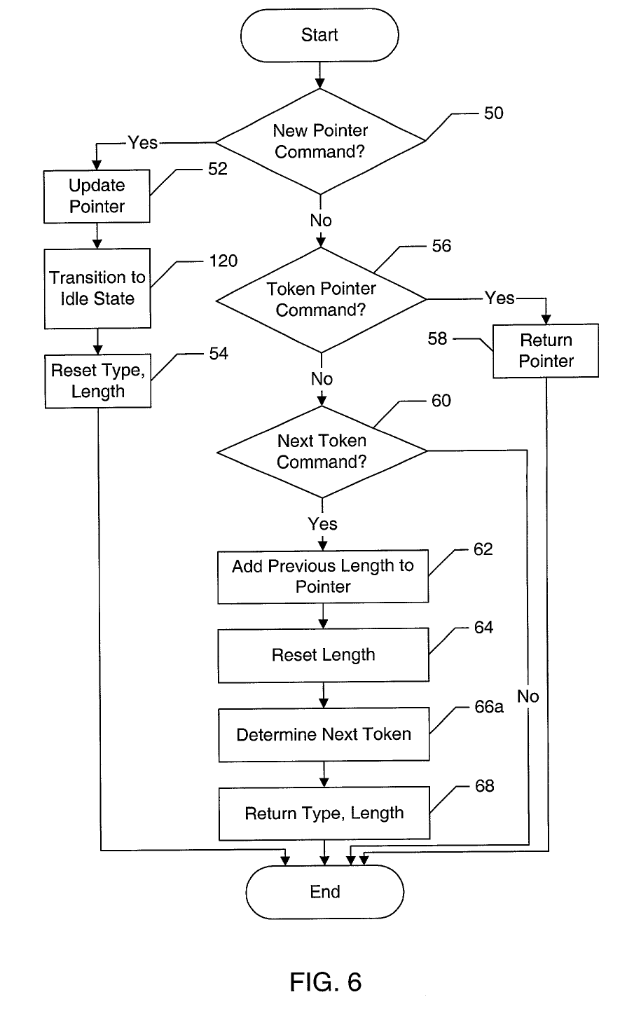

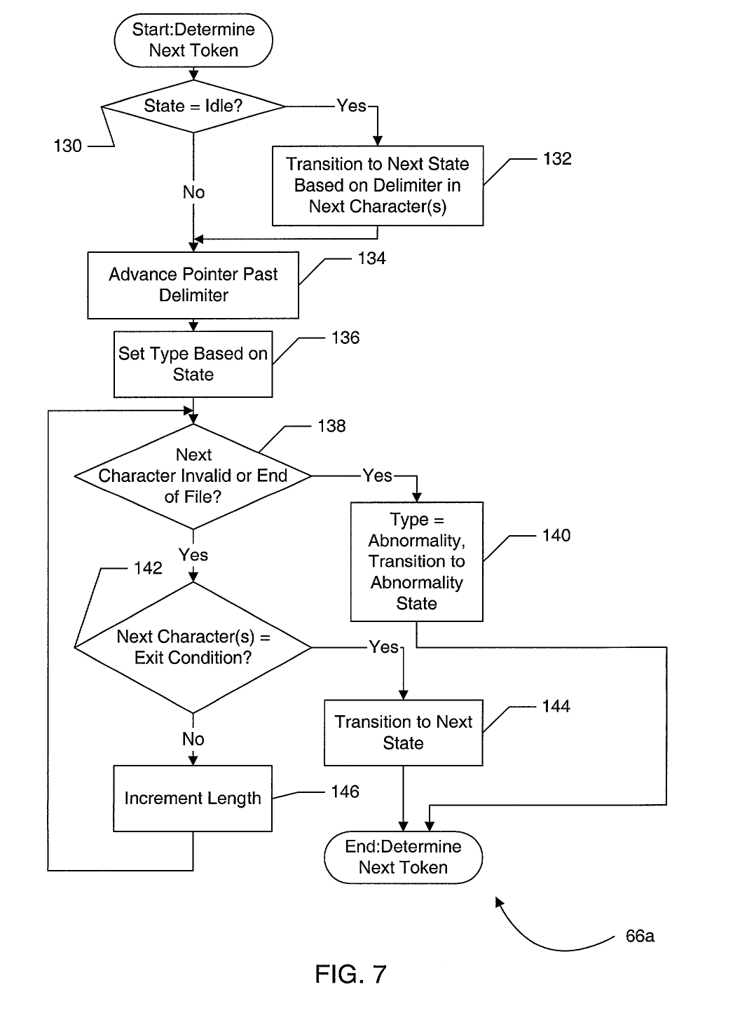

A transition from the idle state 90 to another state may be triggered by processing performed by the markup language accelerator 22 in response to a next token command, as will be illustrated in FIGS. 6 and 7 below. While in states 92, 94, 96, 98, 100, 102, 104, 106, 108, and 114, the markup language accelerator 22 may be scanning the characters from the pointer forward, attempting to locate an end delimiter for that token. Detecting the end delimiter may lead to transitioning back to the idle state 90 (and a return of indications of the next token in response to the next token command) or to another state (e.g. from the element name state 92 to the attribute name state 94). In states transitioned to from a state other than the idle state 90, processing of the token indicated by that state may be initiated by another next token command.

The end of file state 112 is entered if an end of file character is detected. Since the end of the file has been detected, there is no additional processing until a new pointer is provided. Similarly, the abnormality state 110 is entered if an invalid character is detected from the idle state 90, or from any other state if an abnormality is detected in that state. Such abnormalities in other states may include detecting an invalid character, and may include other abnormalities as well (which may be state-dependent).

Turning now to FIG. 6, a flowchart is shown illustrating operation of one embodiment of the markup language accelerator 22. Other embodiments are possible and contemplated. While the blocks shown in FIG. 6 are illustrated in a particular order for ease of understanding, blocks may be performed in other orders, as desired. Furthermore, blocks may be performed in parallel by the circuitry within the markup language accelerator 22. Specifically, circuitry to detect the various commands may operate in parallel. Furthermore, various blocks may occur in different clock cycles in various embodiments. Blocks which are similar to corresponding blocks in FIG. 3 are shown with the same reference numeral as in FIG. 3, and are not described again with regard to FIG. 6.

In addition to the blocks shown in FIG. 3 performed in response to a new pointer command, the embodiment of the markup language accelerator 22 illustrated via FIG. 6 may transition the state machine of FIG. 5 to the idle state 90 (block 120). In this manner, the state of the markup language accelerator 22 may be reset to begin processing the new markup language data. In other respects, the flowchart of FIG. 6 may be similar to the flowchart of FIG. 3. However, the block 66 may differ in its details, as illustrated in FIG. 7 below, and thus is labeled 66a.

Similar to the mention above with respect to the embodiment of FIG. 3, an alternative embodiment of FIG. 6 is contemplated in which the first token may be parsed in response to the new pointer command, and thus the type, pointer, and length may be already generated when the next token command is received. In response to the next token command, the previously generated token information may be provided. Additionally, another token may be located in response to the next token command. In such an embodiment, there may be separate registers to store information on the most recently detected token and the previously detected token.

FIG. 7 is a flowchart illustrating operation of one embodiment of the markup language accelerator 22 for one embodiment of block 66a shown in FIG. 6. Other embodiments are possible and contemplated. While the blocks shown in FIG. 7 are illustrated in a particular order for ease of understanding, blocks may be performed in other orders, as desired. Furthermore, blocks may be performed in parallel by the circuitry within the markup language accelerator 22. Still further, various blocks may occur in different clock cycles in various embodiments.

If the current state of the state machine shown in FIG. 5 is idle (decision block 130), the markup language accelerator 22 may transition the state machine to a new state based on the delimiter in the next character(s) in the markup language data (i.e. the character or characters indicated by the pointer) (block 132). In either case, the markup language accelerator 22 may advance the pointer beyond the delimiter, so that the pointer is pointing to the first character of the next token (block 134). The markup language accelerator 22 sets the type in the registers 36 based on the state (block 136).

The markup language accelerator 22 then scans the token characters, attempting to locate an exit condition for the token. For each character, the markup language accelerator 22 determines if the character is invalid, or is the end of file character (decision block 138). If so, the state machine is transitioned to the abnormality state 110 and the type in the registers 34 is changed to abnormality (block 140). An invalid character is an abnormality because an XML file should not include invalid characters. An end of file character is an abnormality because the end of file should not occur before the end delimiter of the token. In one embodiment, the end of file may be considered an end delimiter for a word token.

If the next character is not invalid or the end of file, the markup language accelerator 22 examines the next character or characters for an exit condition (decision block 142). The number of characters examined may depend on the type of token being scanned. Generally, an exit condition may be an end delimiter or may be an exit to another token type. For example, if an entity beginning delimiter (the ampersand character (“&”)) is detected, then the markup language accelerator 22 may exit to the entity state 104. If an exit condition is detected, the markup language accelerator 22 may transition the state machine to the next state based on the detected exit condition (block 144). If an exit condition is not detected, the markup language accelerator 22 increments the length by the size of the character detected and examines the next character.

While the flowchart of FIG. 7 illustrates processing one character at a time, embodiments of the markup language accelerator may process multiple bytes in parallel, if desired.

It is noted that different embodiments of the markup language accelerator 22 may recognize subsets or supersets of the delimiters shown in FIG. 5, as desired. Any set of delimiters may be recognized in various embodiments. Furthermore, the state machine shown in FIG. 5 is illustrative only. Circuitry which detects the various delimiters to classify the tokens into various token types may be implemented in the form of a state machine or any other form, as desired.

It is noted that the markup language accelerator 22 and circuits therein such as the parse circuit 32, the command interface circuit 30, and fetch control circuit 28 may comprise any hardware circuits for performing the corresponding operations as described herein. Generally, the term “circuit” refers to any interconnection of circuit elements (e.g. transistors, resistors, capacitors, etc.) arranged to perform a given function The term “circuit” does not include processors executing instructions to perform the function.

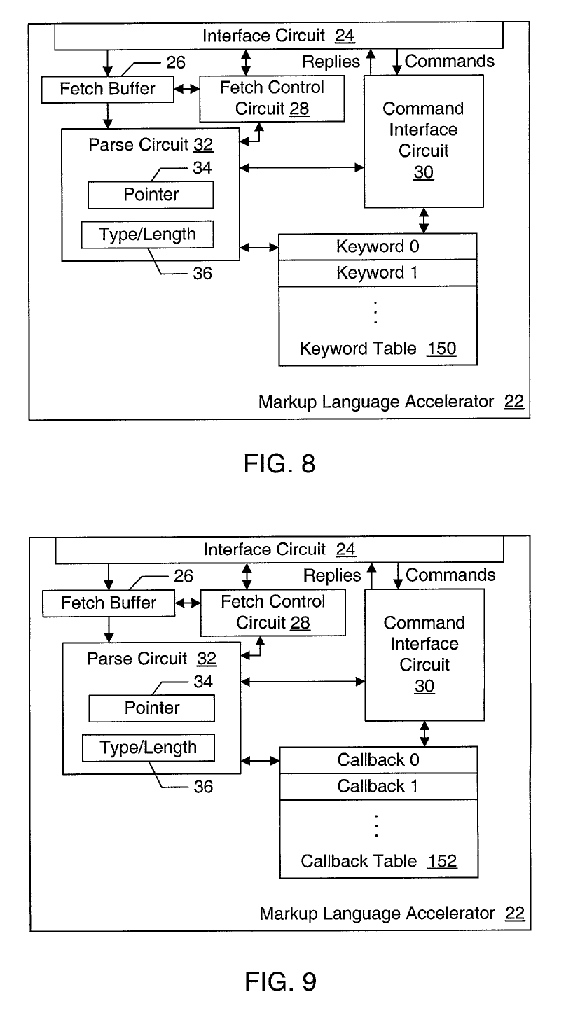

Turning now to FIG. 8, a block diagram of another embodiment of the markup language accelerator 22 is shown. Other embodiments are possible and contemplated. The embodiment of FIG. 8 is similar to the embodiment of FIG. 1, with the addition of a keyword table 150 coupled to the parse circuit 32. The keyword table 150 may also be coupled to the command interface circuit 30.

Generally, the keyword table 150 comprises a plurality of entries. Each entry is configured to store a keyword (a string of one or more characters). The parse circuit 32 may be configured to compare tokens to the keywords in the keyword table, and if a hit is detected, the keyword table entry number may be returned as the token type (or in addition to the token type) to the CPU 12. In this manner, the software markup language processor 42 may be supplied with additional information about the detected token. For example, the software markup language processor 42 may not need to fetch the token pointer from the markup language accelerator 22 and read the token from memory to process the token. Instead, the keyword table entry number may indicate what the token is.

The keyword table 150 may be programmed by software, using commands detected by the command interface circuit 30. For example, read and write keyword table commands may be supported. These commands may be memory mapped in a manner similar to the other commands. The software may, for example, monitor the frequency of various tokens and program the keyword table 150 with frequently occurring tokens. Other embodiments may use other criteria than frequency. Alternatively, the markup language accelerator 22 may monitor the frequency of certain tokens and program the keyword table 150 with frequency occurring tokens.

The keyword table 150 may be constructed from any memory, such as random access memory (RAM), content addressable memory (CAM), individual registers, etc.

Turning now to FIG. 9, a block diagram of another embodiment of the markup language accelerator 22 is shown. Other embodiments are possible and contemplated. The embodiment of FIG. 9 is similar to the embodiment of FIG. 1, with the addition of a callback table 152 coupled to the parse circuit 32. The callback table 152 may also be coupled to the command interface circuit 30.

Generally, the callback table 152 comprises a plurality of entries. Each entry is configured to store an address of a routine in the software markup language processor 42. Additionally, each entry may correspond to a different token type. The routine indicated by the address in the entry may be the routine which handles the corresponding token type. The parse circuit 32 may be configured to read the address from the entry of the callback table 152 corresponding to a given token, and to return that address in response to a command from the CPU 12. The command may be one of the next token or token pointer commands, or may be a separate command from those commands, as desired. The software markup language processor 42 may execute the routine indicated by the address returned from the callback table 152, instead of examining the token type to select the routine to be executed.

The callback table 152 may be programmed by software, using commands detected by the command interface circuit 30. For example, read and write callback table commands may be supported. These commands may be memory mapped in a manner similar to the other commands. The callback table 152 may be constructed from any memory, such as random access memory (RAM), individual registers, etc.

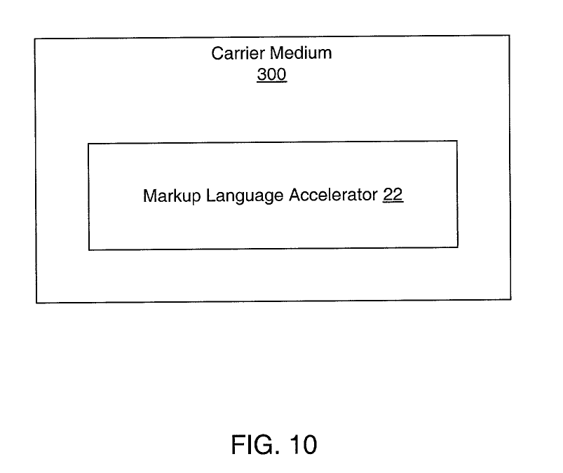

Turning now to FIG. 10, a block diagram of a carrier medium 300 including one or more data structures representative of the markup language accelerator 22 is shown. Generally speaking, a carrier medium may include storage media such as magnetic or optical media, e.g., disk or CD-ROM, volatile or non-volatile memory media such as RAM (e.g. SDRAM, RDRAM, SRAM, etc.), ROM, etc., as well as transmission media or signals such as electrical, electromagnetic, or digital signals, conveyed via a communication medium such as a network and/or a wireless link.

Generally, the data structure(s) of the markup language accelerator 22 carried on the carrier medium 300 may be data structure(s) which can be read by a program and used, directly or indirectly, to fabricate the hardware comprising the markup language accelerator 22. For example, the data structures may include one or more behavioral-level descriptions or register-transfer level (RTL) descriptions of the hardware functionality in a high level design language (HDL) such as Verilog or VHDL. The description(s) may be read by a synthesis tool which may synthesize the description(s) to produce one or more netlists comprising a list of gates in a synthesis library. The netlist(s) comprise a set of gates and interconnect therebetween which also represent the functionality of the hardware comprising the markup language accelerator 22. The netlist(s) may then be placed and routed to produce one or more data sets describing geometric shapes to be applied to masks. The data set(s), for example, may be GDSII (General Design System, second revision) data set(s). The masks may then be used in various semiconductor fabrication steps to produce a semiconductor circuit or circuits corresponding to the markup language accelerator 22. Alternatively, the data structure(s) on the carrier medium 300 may be the netlist(s) (with or without the synthesis library) or the data set(s), as desired.

While the carrier medium 300 carries a representation of the markup language accelerator 22, other embodiments may carry a representation of any portion of the markup language accelerator 22, as desired, including any combination of interface circuits, command interface circuits, parse circuits, pointer registers, type/length registers, fetch buffers, fetch control circuits, etc. Furthermore, the carrier medium 300 may carry a representation of any embodiment of the system 10 or any portion thereof.

Numerous variations and modifications will become apparent to those skilled in the art once the above disclosure is fully appreciated. It is intended that the following claims be interpreted to embrace all such variations and modifications.

What is claimed is:

1. An apparatus comprising:
a pointer storage configured to store a pointer to markup language data; and
a circuit coupled to the pointer storage, wherein the circuit is configured to parse the markup language data into one or more tokens, each token comprising one or more characters from the markup language data, wherein the circuit is configured to parse the markup language data responsive to one or more delimiters in the markup language data.

2. The apparatus as recited in claim 1 wherein the one or more delimiters are whitespace.

3. The apparatus as recited in claim 1 wherein the circuit is configured to generate a type for each of the tokens, wherein the type is dependent upon at least one of the delimiters delimiting the token.

4. The apparatus as recited in claim 3 wherein the type is an element name if the beginning delimiter is a less than character followed by a second character which is not an exclamation point character, a question mark character, or a forward slash character.

5. The apparatus as recited in claim 4 wherein the type of a first token which is a next token after an element name is an attribute name if the beginning delimiter of the first token is whitespace.

6. The apparatus as recited in claim 5 wherein the type of a second token which is the next token after an attribute name is an attribute value if the beginning delimiter of the second token is an equal sign character.

7. The apparatus as recited in claim 3 wherein the type is an instruction if the beginning delimiter is a less than character followed by a question mark character.

8. The apparatus as recited in claim 3 wherein the type is an end element if the beginning delimiter is a less than character followed by a forward slash character.

9. The apparatus as recited in claim 3 wherein the type is a comment if the beginning delimiter is a less than character followed by an exclamation point character followed by two dash characters.

10. The apparatus as recited in claim 3 wherein the type is an entity if the beginning delimiter is an ampersand character.

11. The apparatus as recited in claim 3 wherein the type is a declaration if the beginning delimiter is a less than character followed by an exclamation point character followed by one or more characters which are not two dashes immediately following the exclamation point character.

12. The apparatus as recited in claim 3 wherein the type is an abnormality if the token is not recognized by the circuit.

13. The apparatus as recited in claim 3 further comprising a table coupled to the circuit, the table comprising a plurality of entries, wherein each of the plurality of entries is configured to store a pointer to a software routine and corresponds to one of the types generated by the circuit.

14. The apparatus as recited in claim 13 further comprising an interface circuit coupled to receive software-generated commands, wherein the interface circuit is coupled to the circuit, and wherein, in response to a command requesting a pointer corresponding to a token, the interface circuit is configured to return the pointer from the entry of the table which corresponds to the type of the token.

15. The apparatus as recited in claim 1 wherein the circuit is configured to detect an invalid character within the markup language data and is configured to signal an abnormality in response to the detecting.

16. The apparatus as recited in claim 1 wherein one of the delimiters is an end of file indication.

17. The apparatus as recited in claim 1 further comprising an interface circuit coupled to receive software-generated commands, wherein the interface circuit is coupled to the circuit.

18. The apparatus as recited in claim 17 wherein, in response to a first command which supplies a pointer to markup language data, the interface circuit is configured to cause the pointer storage to update with the pointer supplied by the first command.

19. The apparatus as recited in claim 17 wherein, in response to a second command, the circuit is configured to parse the next token in the markup language data.

20. The apparatus as recited in claim 19 wherein, in response to a third command, the circuit is configured to supply a pointer to the next token in the markup language data.

21. The apparatus as recited in claim 17 wherein the circuit is configured to update the pointer after the token has been delivered, to point to the next character in the markup language data after the end delimiter of the token.

22. The apparatus as recited in claim 1 further comprising a table coupled to the circuit, the table comprising a plurality of entries, wherein each of the plurality of entries is configured to store a string of one or more characters comprising a keyword, and wherein, the circuit is configured to detect whether or not a first token parsed from the markup language data matches one of the keywords in the table.

23. The apparatus as recited in claim 22 further comprising an interface circuit coupled to receive software-generated commands, wherein the interface circuit is coupled to the circuit, and wherein, in response to a command corresponding to the first token, the interface circuit is configured to return an indication of the entry storing the keyword which matches the first token.

24. A carrier medium carrying one or more data structures representing an apparatus, the apparatus comprising:
a pointer storage configured to store a pointer to markup language data; and
a circuit coupled to the pointer storage, wherein the circuit is configured to parse the markup language data into one or more tokens, each token comprising one or more characters from the markup language data, wherein the circuit is configured to parse the markup language data responsive to one or more delimiters in the markup language data.

25. The carrier medium as recited in claim 24 wherein the one or more delimiters are whitespace.

26. The carrier medium as recited in claim 24 wherein the circuit is configured to generate a type for each of the tokens, wherein the type is dependent upon at least one of the delimiters delimiting the token.

27. The carrier medium as recited in claim 26 wherein the type is an element name if the beginning delimiter is a less than character followed by a second character which is not an exclamation point character, a question mark character, or a forward slash character.

28. The carrier medium as recited in claim 27 wherein the type of a first token which is a next token after an element name is an attribute name if the beginning delimiter of the first token is whitespace.

29. The carrier medium as recited in claim 28 wherein the type of a second token which is the next token after an attribute name is an attribute value if the beginning delimiter of the second token is an equal sign character.

30. The carrier medium as recited in claim 26 wherein the type is an instruction if the beginning delimiter is a less than character followed by a question mark character.

31. The carrier medium as recited in claim 26 wherein the type is an end element if the beginning delimiter is a less than character followed by a forward slash character.

32. The carrier medium as recited in claim 26 wherein the type is a comment if the beginning delimiter is a less than character followed by an exclamation point character followed by two dash characters.

33. The carrier medium as recited in claim 26 wherein the type is an entity if the beginning delimiter is an ampersand character.

34. The carrier medium as recited in claim 26 wherein the type is a declaration if the beginning delimiter is a less than character followed by an exclamation point character followed by one or more characters which are not two dashes immediately following the exclamation point character.

35. The carrier medium as recited in claim 26 wherein the type is an abnormality if the token is not recognized by the circuit.

36. The carrier medium as recited in claim 26 further comprising a table coupled to the circuit, the table comprising a plurality of entries, wherein each of the plurality of entries is configured to store a pointer to a software routine and corresponds to one of the types generated by the circuit.

37. The carrier medium as recited in claim 36 further comprising an interface circuit coupled to receive software-generated commands, wherein the interface circuit is coupled to the circuit, and wherein, in response to a command requesting a pointer corresponding to a token, the interface circuit is configured to return the pointer from the entry of the table which corresponds to the type of the token.

38. The carrier medium as recited in claim 24 wherein the circuit is configured to detect an invalid character within the markup language data and is configured to signal an abnormality in response to the detecting.

39. The carrier medium as recited in claim 24 wherein one of the delimiters is an end of file indication.

40. The carrier medium as recited in claim 24 further comprising an interface circuit coupled to receive software-generated commands, wherein the interface circuit is coupled to the circuit.

41. The carrier medium as recited in claim 40 wherein, in response to a first command which supplies a pointer to markup language data, the interface circuit is configured to cause the pointer storage to update with the pointer supplied by the first command.

42. The carrier medium as recited in claim 40 wherein, in response to a second command, the circuit is configured to parse the next token in the markup language data.

43. The carrier medium as recited in claim 40 wherein, in response to a third command, the circuit is configured to supply a pointer to the next token in the markup language data.

44. The carrier medium as recited in claim 40 wherein the circuit is configured to update the pointer after the token has been delivered, to point to the next character in the markup language data after the end delimiter of the token.

45. The carrier medium as recited in claim 24 further comprising a table coupled to the circuit, the table comprising a plurality of entries, wherein each of the plurality of entries is configured to store a string of one or more characters comprising a keyword, and wherein, the circuit is configured to detect whether or not a first token parsed from the markup language data matches one of the keywords in the table.

46. The carrier medium as recited in claim 45 further comprising an interface circuit coupled to receive software-generated commands, wherein the interface circuit is coupled to the circuit, and wherein, in response to a command corresponding to the first token, the interface circuit is configured to return an indication of the entry storing the keyword which matches the first token.
